(19) United States
(12) Patent Application Publication
(10) Pub. No.: US 2012/0274925 A1
(43) Pub. Date: Nov. 1, 2012

(54) Axial light loss sensor system for flow cytometery

(76) Inventors: Yong Chen, San Jose, CA (US); David W. Houck, Milpitas, CA (US)

(21) Appl. No.: 13/456,033

(22) Filed: Apr. 25, 2012

Related U.S. Application Data
(60) Provisional application No. 61/479,244, filed on Apr. 26, 2011.

(51) Int. Cl. G01N 21/59; G01N 21/53

(52) U.S. Cl. 356/73; 356/442

(57) ABSTRACT

An axial light loss sensor system, and methods for measuring axial light loss with improved resolution are provided. Aspects of the present invention include an axial light loss sensor positioned along an axis of irradiation to detect axial light loss resulting from a particle passing a light source intersect in a fluid stream, and an obstruction positioned along the axis of irradiation between the light source intersect and the axial light loss sensor. The obstruction is further positioned so as to have an on-axis opaque surface. The obstruction allows for the measurement of a fringe signal in a far-field with respect to the irradiated particle, in order to measure the axial light loss produced by the particle. The systems and methods described herein find use in, for example, flow cytometery.

### CROSS-REFERENCE TO RELATED APPLICATIONS

Pursuant to 35 U.S.C. §119 (e) this application claims priority to the filing date of U.S. Provisional Patent Application Ser. No. 61/479,244 filed Apr. 26, 2011; the disclosure of which application is herein incorporated by reference.

### INTRODUCTION

A flow cytometer is a powerful tool for counting, examining and sorting microscopic particles suspended in a stream of fluid. In a flow cytometer, signals are derived from fluorescence and/or scatter light from cells and other small particles excited by focused laser beams. In particular, light scattering is widely used in charactering the size, index of refraction and complexity of particles under investigation. For example, forward scatter (FSC), light scattered by particles in directions almost parallel to the excitation laser propagation (e.g., about 1° to about 20°), is approximately proportional to the size of the particle. Side scatter (SSC), e.g., light scattered at about 90° to the laser propagation, is related to the internal structure of the particle. Another parameter often used in flow cytometry applications is axial light loss (ALL) or extinction, measured as the decrease of laser power along its propagation direction due to scattering and absorption by the particle.

The combination of SSC and FSC in a so called dot plot, where the intensity of forward scatter is plotted against side scatter for each particle, provides a powerful tool to distinguish granular cells (granulocyte) from mono-nuclear cells (lymphocyte and monocyte). Both SSC and FSC are “zero background” signals, meaning that in the absence of scattering centers little light is impinged upon photo detectors positioned to detect these signals. SSC and FSC are therefore widely used in commercial flow cytometer instrumentation. However, due to imperfect lyse/wash cycles or certain cell physiologies that may be encountered, there is often significant amounts of cell debris present in the sample. The debris often prohibit the clear characterization of white blood cells (WBC) using the SSC-FSC dot plot. See FIG. 1.

In the late 1980s, it was proposed to replace FSC with axial light loss for the separation of white blood cells (WBC) from debris (See Stewart, C. C. et al., Cytometry 10, p. 426, 1989). As shown in FIG. 2, the focused laser beam used in the flow cytometer diverges rapidly in the far field. To monitor the axial light loss along the laser propagation direction, a pinhole mask is placed in the laser beam path, such that only light propagating along the optical axis is detected by the photo detector placed behind the pinhole. Using a specially designed flow cytometer, Stewart et al. demonstrated clear separation of WBCs from debris with ALL using different types of lyse/washed and lyse/non-washed blood samples. This approach, however, was difficult and expensive to duplicate in commercial instruments due to the special instrument configuration (See Steinkamp, J A. Cytometry 4, p. 83, 1983).

Another approach to differentiate WBCs from debris is to stain the CD45 marker that is present in all WBCs but not in debris. The identification of CD45+ cells provides a clear demarcation of WBCs from debris. However, staining assays are more expensive and time consuming than scattering plot assays. Consequently, FSC and SSC remain the dominant tools employed for distinguishing WBCs from debris in most flow cytometry applications.

### SUMMARY

Aspects of the present invention provide a simple implementation for the measurement of axial light loss (ALL), where this implementation in combination with SSC allows for improved separation of WBCs from debris in flow cytometry applications. Embodiments of the present invention implement a simple ALL with minimal impact to the widely accepted flow cytometry protocols using FSC and SSC. Embodiments of the present invention provide improved resolution in measuring ALL, e.g., as compared to those systems employing conventional pinhole masks.

In one embodiment, instead of the conventional pinhole light mask, a double-slit light mask is placed in front of the axial light loss photo detector. Since the laser intensity distribution at the far field is the Fourier Transform of that intensity at the focus, the light that passes through the double slit is therefore originated from part of the focused laser beam with an intensity pattern indicated by curve 501 in FIG. 5. The pattern is analogous to a signal based on the Young's double slit experiment. Contrary to curve 501 in FIG. 5, curve 501 indicates the intensity distribution of the laser beam at the focal point that matches to a single slit, similar to those used in conventional ALL detectors. The double-slit mask provides much finer resolution at the focal spot as compared to conventional pinhole masks.

In one implementation of the present invention, two rectangular photodiodes, electrically wired in parallel, and mechanically separated from each other, are used for FSC detection. The laser light passing through the gap between the two FSC photodiodes is masked by a double slit. Light passing through the mask then impinges upon the ALL detector.

When resulting SSC-ALL dot plots of non-wash white blood cells (WBC) based on the present invention are compared to similar dot plots obtained under the same conditions using a conventional pinhole masks, it is clear that the results obtained from the double-slit mask provide the best resolution of WBC subpopulations.

### BRIEF DESCRIPTION OF THE FIGURES

The accompanying drawings, which are incorporated herein, form part of the specification. Together with this written description, the drawings further serve to explain the principles of, and to enable a person skilled in the relevant art(s), to make and use a flow cytometer with an axial light loss sensor system in accordance with the present invention.

FIG. 1 is a dot plot showing cellular characterization using forward scatter versus side scatter.

FIG. 2 is a schematic diagram illustrating a laser irradiating a fluid stream, and the resulting divergent beam, with a pinhole mask.

FIG. 3 shows a schematic diagram of a flow cytometer system.

FIG. 4 is a schematic diagram illustrating a laser irradiating a fluid stream, and the resulting divergent beam, with a mask in accordance with one embodiment presented herein.

FIG. 5 shows two illumination signals emitted from an irradiated fluid stream.

FIG. 6A displays the resulted SSC-ALL dot plot of non-wash WBC based on an embodiment presented herein.

FIG. 6B displays the resulted SSC-ALL dot plot of non-wash WBC based on a pinhole mask.

FIG. 7 is a schematic illustration in accordance with one embodiment presented herein.

FIG. 8 is schematic circuit diagram in accordance with one embodiment presented herein.

### DETAILED DESCRIPTION

Provided herein are axial light loss sensor systems, and methods for measuring axial light loss with improved resolution. Aspects of the systems and methods described find use in, for example, flow cytometer systems. For example, in one embodiment, there is provided a flow cytometer system comprising: a fluid conduit; a light source positioned to irradiate a fluid stream present in the fluid conduit, along an axis of irradiation; and an axial light loss sensor positioned along the axis of irradiation to detect axial light loss resulting from a particle passing a light source intersect in the fluid stream. The flow cytometer system further includes an obstruction (or mask) positioned along the axis of irradiation, between the light source intersect and the axial light loss sensor. The mask is further positioned so as to have an on-axis opaque surface. The mask allows the flow cytometer system to measure a fringe signal in a far-field with respect to the irradiated particle, in order to measure the axial light loss produced by the particle.

In one embodiment, the mask is positioned and oriented such that the mask allows the axial light loss sensor to measure a fringe signal in a far-field with respect to the irradiated particle. For example, the double-slit mask is generally positioned so as to have an on-axis opaque surface with two opposing off-axis slits. Each of the off-axis slits may have a width ranging from 1-4 mm, such as about 2 mm. In one embodiment, the mask may be positioned at a distance from the light source intersect that is two times or more, or ten times or more, greater than a spot size created at the light source intersect. Further, in one embodiment, the opaque surface of the double-slit mask blocks ten percent or more, or twenty percent or more, of beam intensity from the light source.

The flow cytometer system may further include: (1) a first forward scatter sensor positioned to detect light scatter, from the particle passing the light source intersect, at angles from about 1-20 degrees from the axis of irradiation; (2) a second forward scatter sensor positioned to detect light scatter, from the particle passing the light source intersect, at angles from about 1-20 degrees from the axis of irradiation, opposite from the first forward scatter sensor relative to the axis of irradiation; and/or (3) one or more side scatter sensor(s) positioned to detect light scatter, from the particle passing the light source intersect, at an angle of about 90 degrees from the axis of irradiation.

In another embodiment, there is provided a flow cytometer system comprising: a fluid conduit; a light source positioned to irradiate the fluid stream along an axis of irradiation; and an axial light loss sensor positioned along the axis of irradiation to detect axial light loss resulting from a particle passing a light source intersect in the fluid stream. In order to measure a fringe signal in the far field, the flow cytometer further includes a mask positioned along the axis of irradiation between the light source intersect and the axial light loss sensor. The mask is positioned so as to have an on-axis opaque surface that blocks at least about ten percent of beam intensity from the light source. In one embodiment, the mask is positioned at a distance from the light source intersect that is at least about two times greater than a spot size created at the light source intersect.

The following detailed description of the figures refers to the accompanying drawings that illustrate an exemplary embodiment of an axial light loss sensor system for a flow cytometer. Other embodiments are possible. Modifications may be made to the embodiment described herein without departing from the spirit and scope of the present invention. Therefore, the following detailed description is not meant to be limiting.

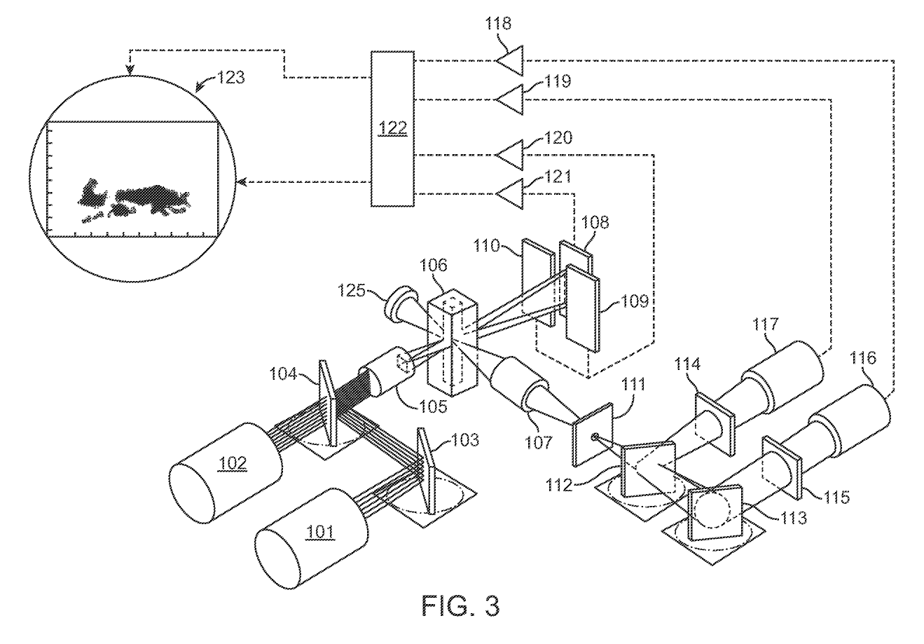

FIG. 3 shows a schematic diagram of a flow cytometer system, such as described in U.S. Pat. No. 4,284,412, which is hereby incorporated by reference in its entirety.

As shown in FIG. 3, the flow cytometer includes a flow channel 106, wherein particles in liquid suspension are passed in a fluid stream, in single file, through a sensing zone. The sensing zone, or light source intersect, is defined by the intersection of the fluid stream with the incident light beam along an axis of irradiation. As the particle passes through the sensing zone, it interacts with incident light in a variety of ways. Some light is absorbed by the particle, other light is scattered at a range of angles relative to the axis of irradiation. Furthermore, depending upon the nature of the particle itself, and any dyeing or staining to which the particle may previously have been subjected, fluorescence emissions may also occur.

Accordingly, photosensors located at various orientations with respect to the fluid stream and the axis of irradiation permit detection of a unique set of responses for each given type of particle. For example, FIG. 3 includes a first laser 101 and a second laser 102, with the coherent light emitted by each being variously deflected via minors 103 and 104 and a lens 105 to the sensing zone of the flow channel 106. The fluid stream is carried in laminar fashion within a flowing fluid sheath, to insure that the particles line up in single file and are individually irradiated in the sensing zone. Hence, as each particle is irradiated by light from the lens, interaction of the particle with the light may be sensed.

As shown in FIG. 3, an axial light loss sensor 108 detects the amount of light blocked by the particle. Forward light scatter at angles between about 1-20 degrees is detected by photosensors 109 and 110. Electrical signals generated by the sensors 108, 109 and 110 are coupled to amplifiers 120 and 121, which present electrical signals for subsequent analysis and/or display.

As shown in FIG. 3, light which is emitted from the particle by virtue of a fluorescence response, or side scatter at angles of about 90 degrees, is sensed at right angles both to the direction of the fluid stream and to the axis of irradiation. In FIG. 3, a spherical minor 125 and a condenser lens 107 collects this light, and couples this light through an aperture 111, successively to a dichroic mirror 112, and to a second minor 113. A first color filter 114 (e.g., to pass relatively long wavelength light) conveys select light from the dichroic minor 112 to photosensor 117 (e.g. a photomultiplier tube). A second filter 115 selectively passes light of a different color (e.g., relatively short wavelength light) from the second mirror 113 to a second photosensor 116. Electrical signals from sensors 116 and 117 are coupled to amplifiers 118 and 119, and thereby also presented for subsequent processing.

A sensor selector 122 generates output histograms utilizing signals from the amplifiers 118 through 121. An example histogram is shown at display 123, with each point on the histogram representing an individual particle. Clusters or aggregates of indicators on the histogram represent groups of particles of similar type.

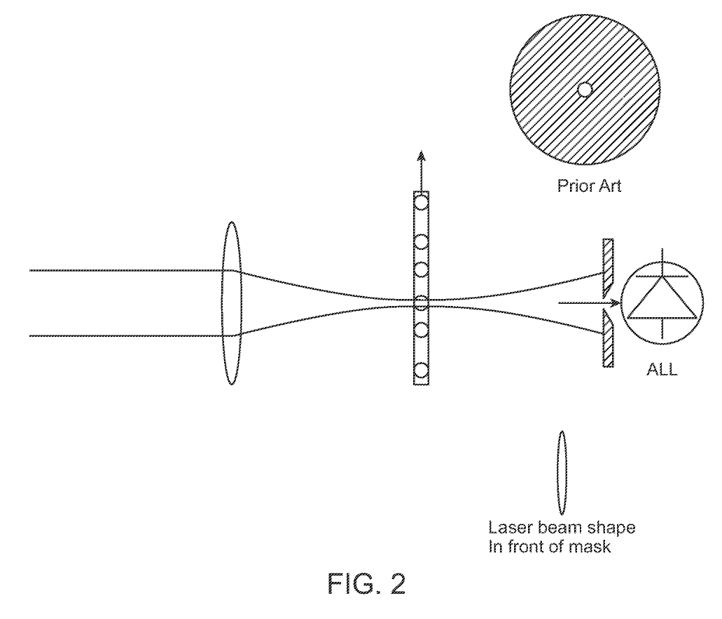

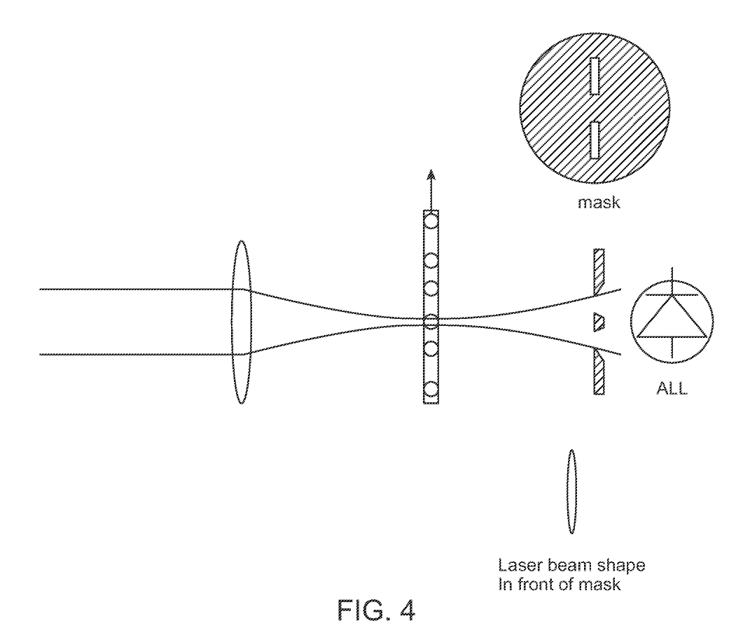

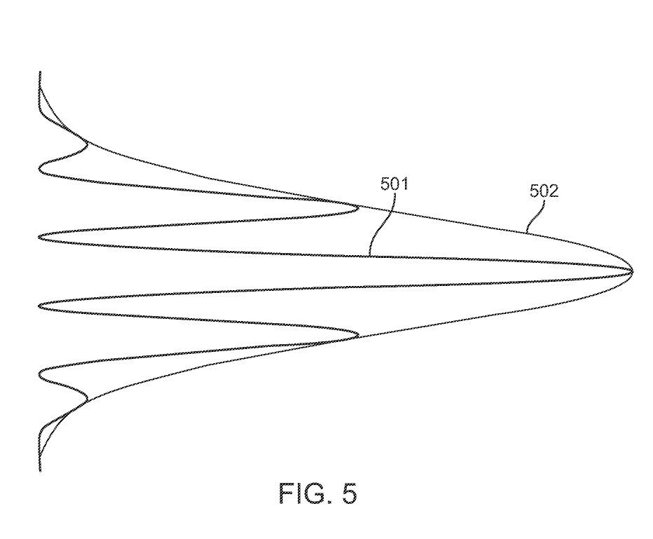

FIG. 4 is the schematic diagram illustrating one embodiment presented herein. Instead of the conventional pinhole light mask, as shown in FIG. 2, a double-slit mask is placed in front of the ALL photosensor. Since the laser intensity distribution at the far field is the Fourier Transform of that laser intensity at the light source intersect, the light that passes through the double-slit mask is therefore originated from part of the focused laser beam with an intensity pattern indicated by the curve 501 in FIG. 5. Contrary to curve 501, curve 502 indicates the intensity distribution of the laser beam at the near field relative to the light source intersect, and would match the curve perceived by a pinhole mask ALL sensor system. The double-slit mask therefore provides greater resolution at the focal spot than can be achieved with a conventional pinhole mask.

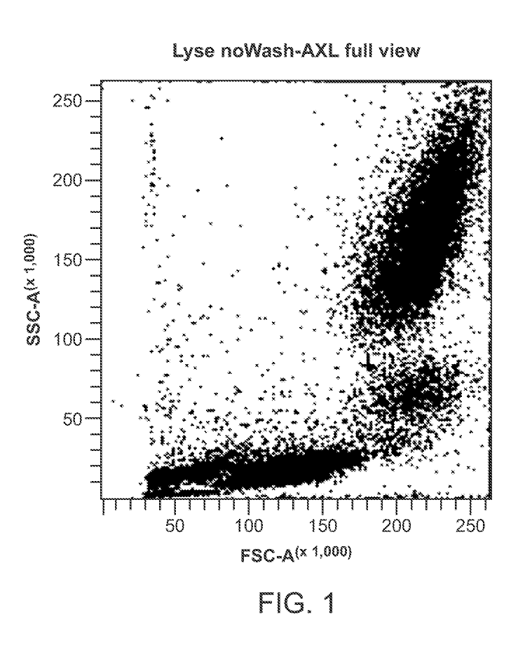

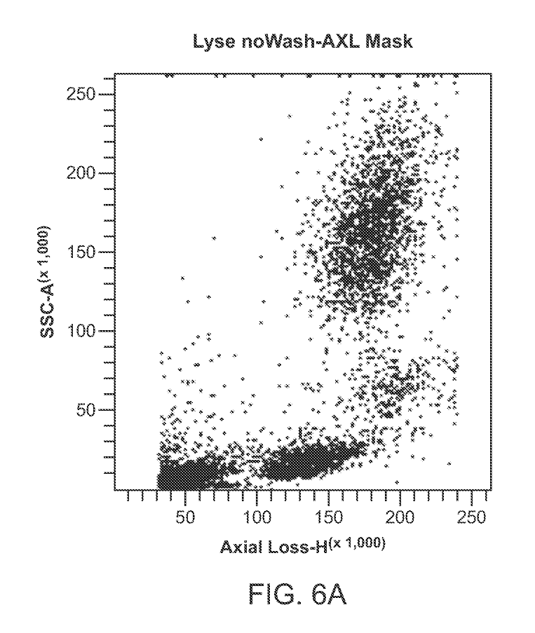

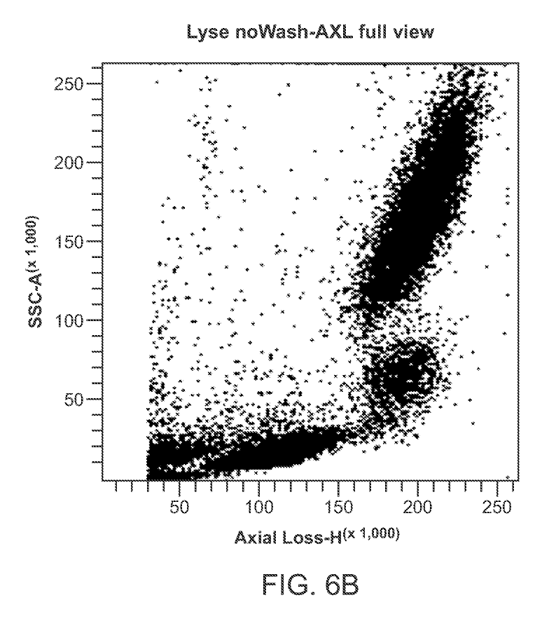

FIG. 6A displays a SSC-ALL dot plot of non-wash WBC sample based on a double-slit mask in accordance with one embodiment presented herein. For comparison, a similar plot obtained under the same condition using a pinhole mask is shown in FIG. 6B. While both plots improved the separation of lymphocyte populations from debris, and the resolution of monocytes in comparison to the SSC-FSC plot shown in FIG. 1, it is clear that the results obtained from the double-slit mask provide the best resolution of WBC subpopulations.

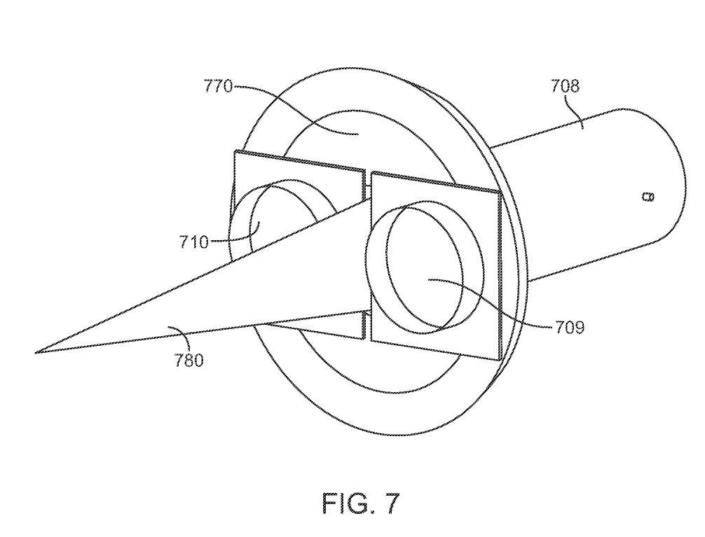

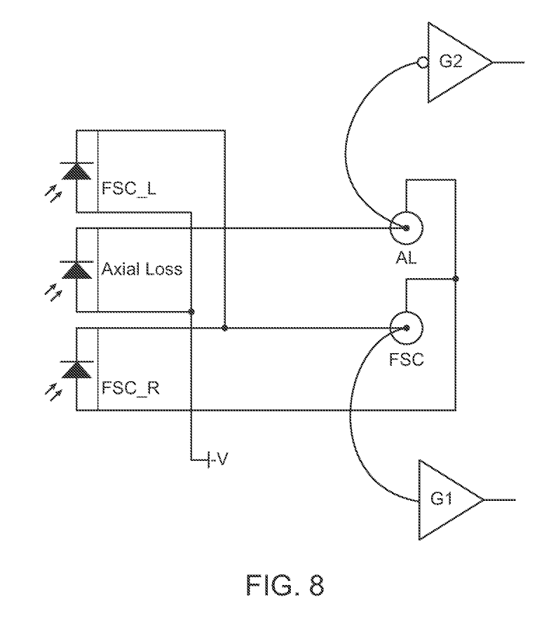

FIG. 7 is a schematic illustration in accordance with one embodiment presented herein. FIG. 8 is schematic circuit diagram in accordance with the embodiment shown in FIG. 7.

As shown, a divergent light beam 780 is transmitted between two photosensors (e.g., photodiodes) 710 and 709. The divergent light beam 780 impinges on a mask 770, such as the double-slit mask shown in FIG. 4. An ALL photosensor (e.g., photodiode) 708 is provided behind mask 770 to measure the fringe signal of light beam 780. The signal from ALL photosesnor 708 is then processed through a gain amplifier as shown in FIG. 8.

Each photosensor 710 and 709, is represented by photodiode FSC_L and FSC_R in FIG. 8, which are electrically wired in parallel. In one embodiment, photosensors 710 and 709 are mechanically separated from each other opposite each with respect to the axis of irradiation. Photosensors 710 and 709 are used for FSC detection at angles of about 1-20 degrees from the axis of irradiation.

### Methods

The systems described above may be used for methods of measuring axial light loss, e.g., in a flow cytometer system. In one embodiment, there is provided a method comprising: (1) irradiating a particle within a fluid stream with a light source; and (2) measuring a fringe signal in a far-field with respect to the irradiated particle in order to measure an axial light loss produced by the particle. The method may further include: (3) positioning a double-slit mask between the irradiated particle and an axial light loss sensor such that the double-slit mask includes an on-axis opaque surface with two opposing off-axis slits; (4) positioning the mask at a distance from the irradiated particle that is at least about two to ten times greater than a spot size created at the point of irradiation; and/or (5) positioning the mask such that the opaque surface of the double-slit mask blocks at least about ten to twenty percent of beam intensity from the light source.

In another embodiment, there is provided a method of measuring axial light loss in a flow cytometer system, the method comprising: (1) inserting a particle sample into a flow cytometer system; (2) irradiating the particle with a light source; and (3) reading a fringe signal in a far-field with respect to the irradiated particle in order to measure an axial light loss produced by the particle. The flow cytometer system may include a double-slit mask positioned between the irradiated particle and an axial light loss sensor such that the double-slit mask includes an on-axis opaque surface with two opposing off-axis slits. In various embodiments, the mask may be positioned at a distance from the irradiated particle that is two times or more, or ten times or more, greater than a spot size created at the point of irradiation. The opaque surface of the double-slit mask may block ten percent or more, or twenty percent or more, of beam intensity from the light source.

In yet another embodiment, there is provided a method of setting up a flow cytometer by positioning an obstruction between a light source and an axial light loss sensor, along an axis of irradiation, such that the obstruction includes an on-axis opaque surface that blocks light emitted from the light source. The obstruction allows the axial light loss sensor to read a fringe signal in a far-field with respect to an irradiated particle, and thus measure an axial light loss produced by the irradiated particle. The method may further include: (1) positioning the obstruction at a distance from the irradiated particle that is two times or more, or ten times or more, greater than a spot size created at a point of irradiation; and/or (2) positioning the obstruction such that the opaque surface of the obstruction blocks ten percent or more, or twenty percent or more, of beam intensity from the light source.

### Conclusion

The foregoing description of the invention has been presented for purposes of illustration and description. It is not intended to be exhaustive or to limit the invention to the precise form disclosed. Other modifications and variations may be possible in light of the above teachings. The embodiments were chosen and described in order to best explain the principles of the invention and its practical application, and to thereby enable others skilled in the art to best utilize the invention in various embodiments and various modifications as are suited to the particular use contemplated. It is intended that the appended claims be construed to include other alternative embodiments of the invention; including equivalent structures, components, methods, and means.

It is to be appreciated that the Detailed Description section, and not the Summary and Abstract sections, is intended to be used to interpret the claims. The Summary and Abstract sections may set forth one or more, but not all exemplary embodiments of the present invention as contemplated by the inventor(s), and thus, are not intended to limit the present invention and the appended claims in any way.

It is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination. All combinations of the embodiments are specifically embraced by the present invention and are disclosed herein just as if each and every combination was individually and explicitly disclosed, to the extent that such combinations embrace operable processes and/or devices/systems/kits. In addition, all sub-combinations listed in the embodiments describing such variables are also specifically embraced by the present invention and are disclosed herein just as if each and every such sub-combination of chemical groups was individually and explicitly disclosed herein.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

What is claimed is:

1. An axial light loss sensor system, the system comprising:
an on-axis axial light loss sensor; and
an on-axis obstruction positioned between the axial light loss sensor and a light source, along an axis of irradiation, so as to measure a far-field fringe signal at the axial light loss sensor.

2. The axial light loss sensor system of claim 1, wherein the obstruction is a double-slit mask positioned so as to have an on-axis opaque surface with two opposing off-axis slits.

3. The axial light loss sensor system of claim 2, wherein the opaque surface of the double-slit mask blocks ten percent or more of beam intensity from the light source.

4. The axial light loss sensor system of claim 2, wherein the opaque surface of the double-slit mask blocks twenty percent or more of beam intensity from the light source.

5. The axial light loss sensor system of claim 2, wherein each of the off-axis slits has a width ranging from 1-4 mm.

6. The axial light loss sensor system of claim 2, wherein each of the off-axis slits has a width of 2 mm.

7. The axial light loss sensor system of claim 1, wherein the obstruction includes an on-axis opaque surface that blocks ten percent or more of beam intensity from the light source.

8. The axial light loss sensor system of claim 1, wherein the obstruction is positioned at a distance from the irradiated light source intersect that is two times or more greater than a spot size created at the light source intersect.

9. The axial light loss sensor system of claim 1, wherein the obstruction is positioned at a distance from the light source intersect that is ten times or more greater than a spot size created at the light source intersect.

10. A flow cytometer system, the system comprising:
a fluid conduit;
a light source positioned to irradiate a fluid stream present within the fluid conduit, along an axis of irradiation;
an axial light loss sensor positioned along the axis of irradiation to detect axial light loss resulting from a particle passing a light source intersect in the fluid stream; and
an obstruction positioned along the axis of irradiation between the light source intersect and the axial light loss sensor

11. The flow cytometer system of claim 10, wherein the obstruction is a double-slit mask positioned so as to have an on-axis opaque surface with two opposing off-axis slits.

12. The flow cytometer system of claim 11, wherein the opaque surface of the double-slit mask blocks ten percent or more of beam intensity from the light source.

13. The flow cytometer system of claim 11, wherein the opaque surface of the double-slit mask blocks twenty percent or more of beam intensity from the light source.

14. The flow cytometer system of claim 11, wherein each of the off-axis slits has a width ranging from 1-4 mm.

15. The flow cytometer system of claim 11, wherein each of the off-axis slits has a width of 2 mm.

16. The flow cytometer system of claim 10, wherein the obstruction includes an on-axis opaque surface that blocks ten percent or more of beam intensity from the light source.

17. The flow cytometer system of claim 10, wherein the obstruction is positioned at a distance from the light source intersect that is two times or more greater than a spot size created at the light source intersect.

18. The flow cytometer system of claim 10, wherein the obstruction is positioned at a distance from the light source intersect that is ten times or more greater than a spot size created at the light source intersect.

19. The flow cytometer system of claim 10, further comprising:
a first forward scatter sensor positioned to detect light scatter, from the particle passing the light source intersect, at angles from 1-20 degrees from the axis of irradiation.

20. The flow cytometer system of claim 19, further comprising:
a second forward scatter sensor positioned to detect light scatter, from the particle passing the light source intersect, at angles from 1-20 degrees from the axis of irradiation, opposite from the first forward scatter sensor relative to the axis of irradiation.

21. The flow cytometer system of claim 10, further comprising:
a side scatter sensor positioned to detect light scatter, from the particle passing the light source intersect, at an angle of about 90 degrees from the axis of irradiation.

22. A method of setting up a flow cytometer system, the method comprising:
positioning an obstruction between a light source and an axial light loss sensor, along an axis of irradiation, such that the obstruction includes an on-axis opaque surface that blocks light emitted from the light source and allows the axial light loss sensor to read a fringe signal in a far-field with respect to an irradiated particle, and thus measure an axial light loss produced by the irradiated particle.

23. The method of claim 22, further comprising:
positioning the obstruction at a distance from the irradiated particle that is two times or more greater than a spot size created at a point of irradiation.

24. The method of claim 22, further comprising:
positioning the obstruction at a distance from the irradiated particle that is ten times or more greater than a spot size created at a point of irradiation.

25. The method of claim 22, wherein the opaque surface of the obstruction blocks ten percent or more of beam intensity from the light source.

26. The method of claim 22, wherein the opaque surface of the obstruction blocks twenty percent or more of beam intensity from the light source.

27. A method of measuring axial light loss in a flow cytometer system, the method comprising:
inserting a particle sample into a flow cytometer system;
irradiating the particle with a light source; and
reading a fringe signal in a far-field with respect to the irradiated particle in order to measure an axial light loss produced by the particle.

28. The method of claim 27, wherein a double-slit mask is positioned between the irradiated particle and an axial light loss sensor such that the double-slit mask includes an on-axis opaque surface with two opposing off-axis slits.

29. The method of claim 28, wherein the mask is positioned at a distance from the irradiated particle that is two times or more greater than a spot size created at the point of irradiation.

30. The method of claim 28, wherein the mask is positioned at a distance from the irradiated particle that is ten times or more greater than a spot size created at the point of irradiation.

31. The method of claim 28, wherein the opaque surface of the double-slit mask blocks ten percent or more of beam intensity from the light source.

32. The method of claim 28, wherein the opaque surface of the double-slit mask blocks twenty percent or more of beam intensity from the light source.

33. The method of claim 28, wherein each of the off-axis slits has a width ranging from 1-4 mm.
